(19) United States
(12) Patent Application Publication
(10) Pub. No.: US 2007/0045522 A1
(43) Pub. Date: Mar. 1, 2007

(54) Omnidirectional electromagnetic sensing device

(76) Inventor: Yi-Tsung Chien, Yi-Lan Hsien (TW)

Correspondence Address: LIN & ASSOCIATES INTELLECTUAL PROPERTY, P.O. BOX 2339, SARATOGA, CA, 95070-0339, US

(21) Appl. No.: 11/218,075

(22) Filed: Sep. 1, 2005

(51) Int. Cl. H01J 40/14

(52) U.S. Cl. 250/221

(57) ABSTRACT

An omnidirectional electromagnetic sensing device is provided, including a passive sensor and a metal plate having a convex surface. By using the metal convex surface to reflect and collect electromagnetic waves from various angles, the passive sensor is not limited to the sensible angle of the sensor. The presence of an object in the sensing coverage can be detected by signals collected by the sensor. Therefore, the omnidirectional electromagnetic sensing device can be used as a trigger to an intrusion alarm system and automatic control process. In comparison with conventional detection system that may require a plurality of sensors, the omnidirectional electromagnetic sensor provides a wide coverage, cost-effective and mobile solution to various surveillance applications.

### FIELD OF THE INVENTION

The present invention generally relates to an electromagnetic sensing device for detecting the presence of an object, and more specifically to an omnidirectional electromagnetic sensing device, which is not limited to the sensible angle of the sensor.

### BACKGROUND OF THE INVENTION

The rapid growth of the surveillance industry indicates that the concern for the safety of people and property is an increasingly pressing issue for many commercial establishments as well as households. One of the most commonly used apparatus in the surveillance industry is the use of the sensor. An electromagnetic sensor uses the transmission and reception of electromagnetic waves, such as infrared, thermal radiation, and microwave, to detect the presence of an object. The electromagnetic sensor is applicable of detecting an obstacle object or an intruder, and to automatic control process.

However, the conventional electromagnetic sensor has a limited sensing capability, which is usually measured in angles. For example, the sensor light used in most staircases can only sense objects or movement in an area within a range of 120°. In most situations, the sensor must be installed along the path where people will walk by, so that the sensor light can detect them and be activated. If surveillance area is too large to be covered by a single sensor light, it is not unusual to see people waving hands or walking towards front of the sensor in order to make the light on. This is, of course, inconvenient, and may even pose severe security problems at some critical applications.

A conventional method for solving such problems is to use a plurality of sensors in parallel to achieve a wider range of coverage angles. However, this usually leads to further problems, including arrangement and calibration of the sensors, signal capturing delay, and higher installation and operation cost.

U.S. Pat. No. 5,107,120 disclosed a passive infrared detector, including the use of refractive lenses to increase the coverage of the detector. As shown in FIG. 1, the passive infrared detector includes a pyroelectric sensor 101 with three pairs of contiguous, active elements 102 and a Fresnel lens 103 with a plurality of segments 104. Each of segments has an optical center 105 and an equivalent focal length. Each pair of active elements 102 are disposed in different plane, with each focal center 105 juxtaposed to the plane of at least one of those active elements, substantially at the focal length.

Although the disclosed infrared detector can achieve the coverage of 180° horizontally, the vertical coverage of the disclosed detector is still less than 90°. Furthermore, the disclosed infrared detector may require incorporating a plurality of sensors inside the refractive lenses to achieve the wide angle coverage, thus a higher manufacturing cost.

Other prior art devices, such as disclosed in U.S. Pat. No. 6,118,474, U.S. Pat. No. 6,222,683, U.S. Pat. No. 6,449,103, U.S. Pat. No. 6,611,282, and U.S. Pat. No. 6,793,356, have used reflecting surfaces to increase the filed of view. All such prior arts used camera to capture the image that was reflected in a mirror and thus got larger filed of view. Some of the prior art devices may use the arrangement and the combination of plural cameras or mirrors. Their major differences are in surface forms of the mirrors, the distance or calibration between the camera and mirror, the way of arrangement, and so on. These factors will affect the resolution of the captured image, filed of view, distortion, size and position of the blind spot, and single-view point problem, etc. In other words, the quality of captured images must be taken into consideration by these prior art devices.

It is, therefore, imperative to find a cost-effective sensing device, which is not limited to the sensible angle of the sensor and need not consider quality of captured image, thereby, providing a wider angle coverage that many applications demand.

### SUMMARY OF THE INVENTION

The present invention has been made to overcome the aforementioned drawback of conventional electromagnetic sensors. The primary object of the present invention is to provide an omnidirectional electromagnetic sensing device with wide angle of coverage.

Another object of the present invention is to provide an omnidirectional electromagnetic sensing device that is cost-effective and easy to manufacture.

Yet another object of the present invention is to provide a mobile omnidirectional electromagnetic sensing device that can be easily moved about to different locations as the occasion demands.

To achieve the aforementioned objects, the omnidirectional electromagnetic sensing device of the present invention comprises a metal plate having a metal convex surface and a passive sensor. By using the metal convex surface to reflect electromagnetic waves from various angles to a point or a small area, the electromagnetic sensing device of the present invention can collect the reflected electromagnetic waves and provide large angle of coverage. Furthermore, the present invention can be used as a trigger to an intrusion alarm system or an automatic control process.

In compared with conventional detection system that may require a plurality of sensors, the present invention provides a cost-effective and mobile solution to various surveillance applications.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a cross-sectional view of a conventional passive infrared detector.

FIG. 2 illustrates how a metal convex reflects and collects electromagnetic waves from various angles.

FIG. 3a is a side view of an embodiment of an omnidirectional electromagnetic sensing device according to the present invention.

FIG. 3b is a side view of another embodiment of an omnidirectional electromagnetic sensing device according to the present invention, which further includes a control unit as a detection system.

FIGS. 4a-4e are some examples of convex surfaces.

FIG. 5 illustrates how the relative locations between the metal convex surface and the passive sensor in FIG. 3 affect the sensing coverage.

FIG. 6a shows an exemplary embodiment of the present invention.

FIG. 6b shows a conventional sensor for comparison with the exemplary embodiment in FIG. 6a.

FIGS. 7a-7b show the present invention applied in various situations.

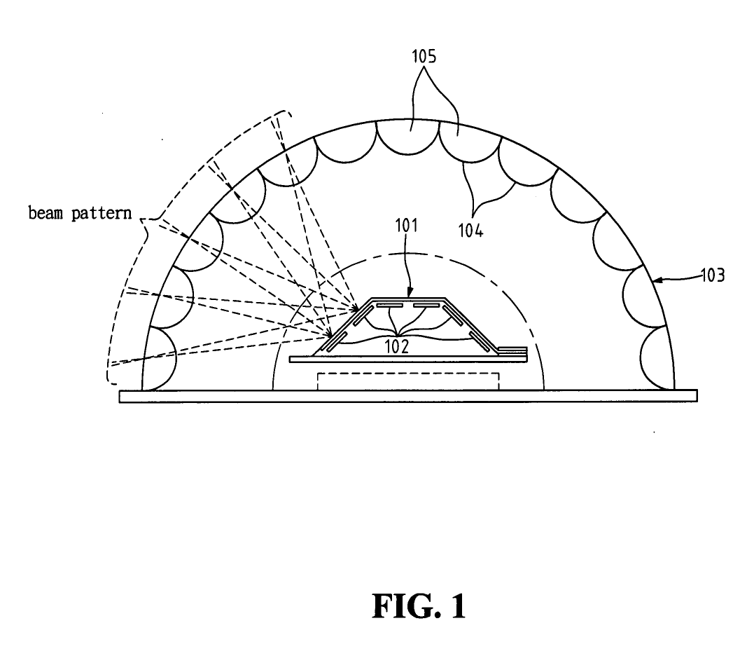

### DETAILED DESCRIPTION OF THE PREFERRED EMBODIMENTS

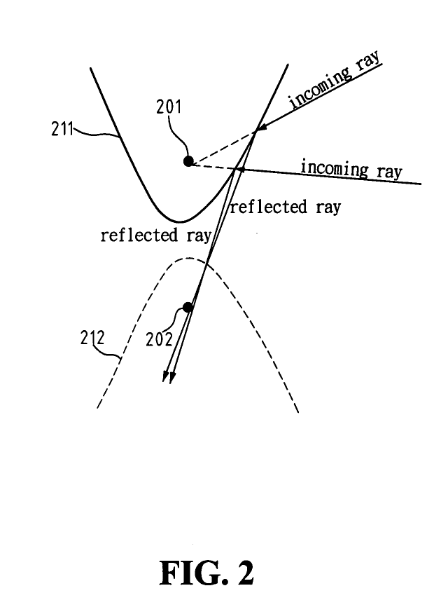

FIG. 2 illustrates how a metal convex surface reflects and collects electromagnetic waves from various angles. The metal convex surface in FIG. 2 is a hyperboloid-shaped surface, which has the characteristic to reflect all the incoming rays towards the focus 201 of the convex surface 211 to pass the focus 202 of the opposite virtual convex surface 212. Therefore, the hyperboloid convex surface 211 in FIG. 2 is able to reflect the incoming electromagnetic waves to a single point 202.

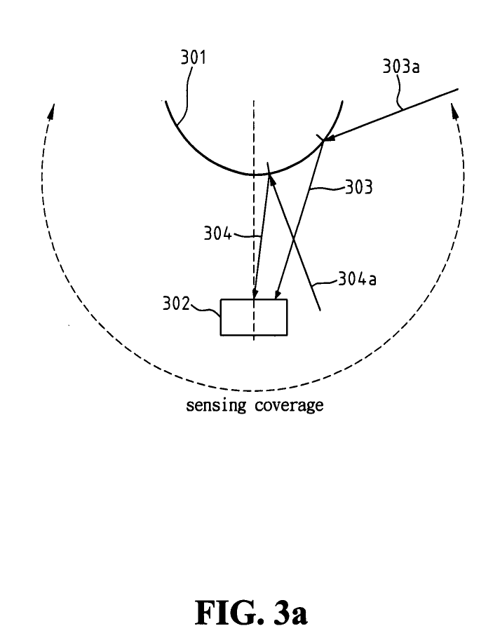

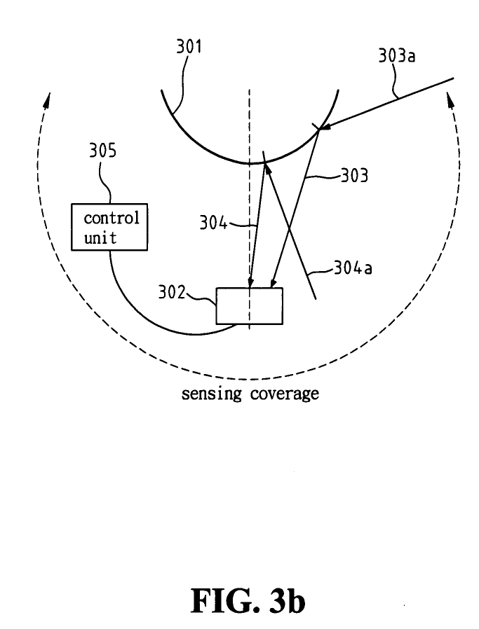

FIG. 3a is a side view of an embodiment of an omnidirectional electromagnetic sensing device according to the present invention. As shown in FIG. 3, the omnidirectional electromagnetic sensing device comprises a metal plate of convex surface 301 and a passive sensor 302. The passive sensor 302 is placed at a distance from the metal convex surface 301 to collect the reflected electromagnetic waves, such as the two reflected electromagnetic rays 303 and 304. The two reflected electromagnetic rays 303 and 304 are reflected from rays 303a and 304a at different angles respectively. Ray 303a arrives at metal convex 301 from a higher angle, while ray 304a from a lower angle. Because of the reflectivity of metal convex 301, both rays 303a and 304a are reflected to and collected by the passive sensor 302. Therefore, the presence of an object either at a higher angle or a lower angle can be detected by the passive sensor 302.

FIG. 3b is a side view of another embodiment of an omnidirectional electromagnetic sensing device according to the present invention, which further includes a control unit 305 as a detection device. The control unit 305 is connected with the passive sensor 302. When an object is within the coverage where the electromagnetic waves will be reflected to the passive sensor 302, the control unit 305 is triggered. Therefore, the present invention can be used as a trigger to a detection system such as intrusion detection system and automatic control process.

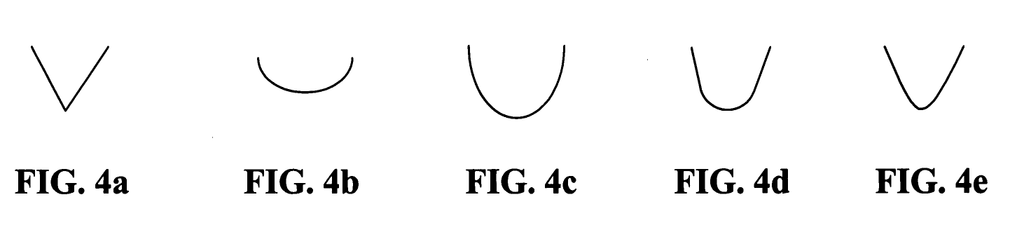

The passive sensor can be an electromagnetic sensor, such as thermal radiation sensor. The metal convex surface can be of various shapes, as long as the surface can reflect the incoming electromagnetic waves to a point or a small area where the electromagnetic sensor will be placed according to the present invention. FIGS. 4a-4e are some examples of such convex surfaces including cone, sphere, ellipse, hyperboloid, and paraboloid, respectively.

The material for manufacturing the metal convex surface depends on the electromagnetic waves sensible by the sensor. Because the reflectivity of material depends on the frequency of the electromagnetic waves and the conductivity of the material, a metal with higher conductivity can be used for reflecting higher frequency electromagnetic waves. Furthermore, a multi-layer coating of various metals can be applied to the convex surface to achieve full reflectivity.

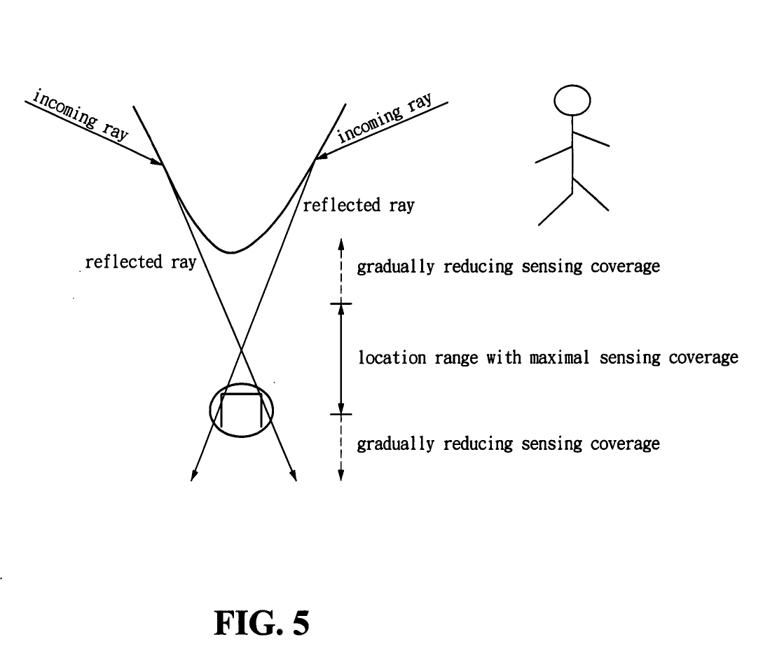

FIG. 5 illustrates how the distance between the metal convex surface and the passive sensor affect the sensing coverage. As shown in FIG. 5, for different shape and size of the metal convex surface, there exists a location range within which the maximum amount of electromagnetic waves will be sensed. Preferably, the passive sensor should be placed within this location range so that the sensor is able to detect objects in a wider coverage. For example, the reflected rays from a hyperboloid convex surface will be collected at the focus of the opposite virtual surface; therefore, the passive sensor is preferably placed at the opposite focus as closely as possible to obtain the largest sensing coverage and furthermore to reduce sensor size. In this case, closer position to the convex reduces the whole device size but needs larger sensor. In other words, the deviation of the passive sensor from a point or an area affects the sensing coverage and the applicable sizes of the passive sensor and the device of the invention. Thereby, the deviation of the passive sensor from a point or an area is adjustable to meet the desired sensing coverage and the applicable sizes of the passive sensor and the device.

As mentioned earlier, the convex surface can reflect the incoming electromagnetic waves to a point or a small area where the electromagnetic sensor will be placed according to the present invention. The location of the point and the size of the small area will vary according to the curvature equation of the convex surface.

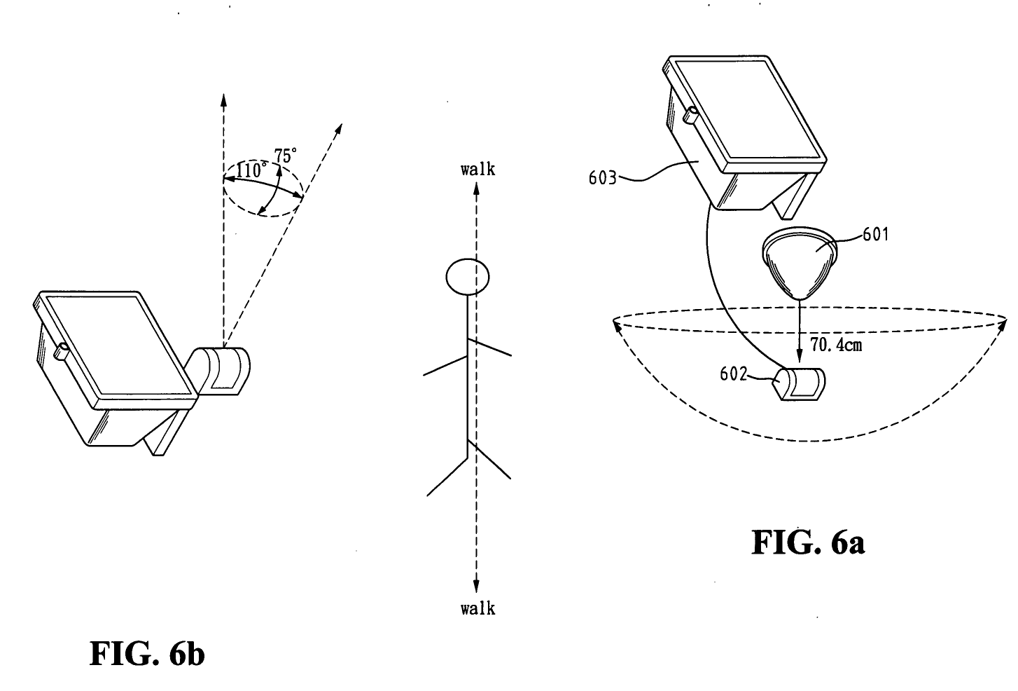

FIG. 6a shows an exemplary embodiment of the present invention using an aluminum plated-film as the metal convex surface 601 for reflection. A thermal radiation sensor 602 is used as the passive sensor, connected to a light source 603 as a detection system. When a person is within the sensing coverage, the light is triggered and turned on. A person usually radiates heat, which is a kind of electromagnetic wave having the wavelength of about 1000 nm, and the reflectivity of the aluminum coating is about 86.7% for 800 nm wavelength. The convex surface is a known hyperboloid function and the opposite virtual surface's focus is 70.4 mm away from the crest of the convex surface. The thermal radiation sensor 602 is placed at about 70 mm below the hyperboloid convex surface. The experiments show that the exemplary embodiment shown in FIG. 6a can provide seamless coverage of detection. In comparison, the conventional sensor shown in FIG. 6b provide only cone coverage of 110° horizontally and 75° vertically.

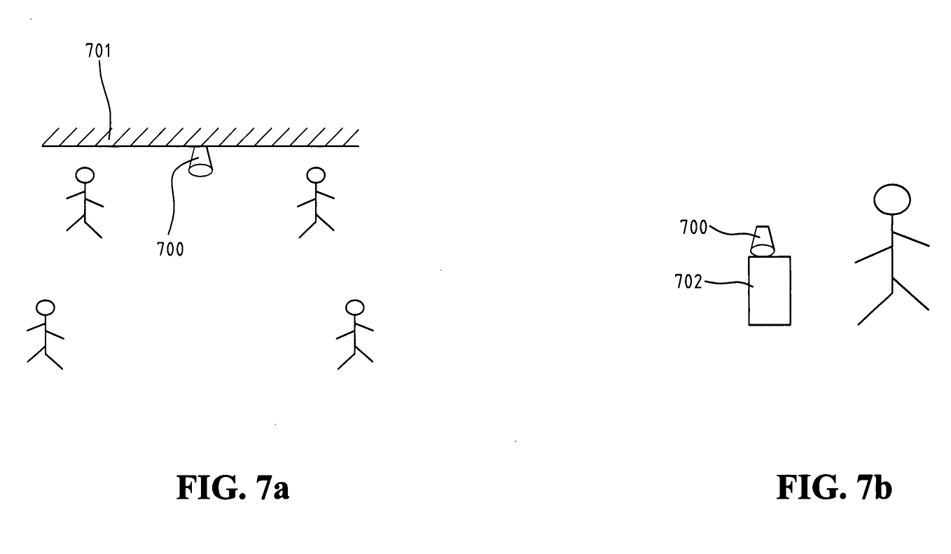

FIGS. 7a-7b shows the electromagnetic sensing device of the present invention being applied in various situations. When used with a detection system, the present invention can be used as a trigger to the alarm system upon sensing the presence of an object. The alarm system can produce visual or audio signals to attract attention, such as light, blinking light or noises, or even smell. The electromagnetic sensing device 700 of the present invention can be mounted on a fixed base, such as ceiling 701 or wall, as many conventional applications. This is illustrated in FIG. 7a. In addition, the electromagnetic sensing device 700 can also be used on a mobile appliance 702 that can be moved to different places if necessary, as shown in FIG. 7b.

In comparison with the conventional techniques, the present invention provides an omnidirectional electromagnetic sensing device that is both cost-effective and mobile.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An omnidirectional electromagnetic sensing device, comprising:
a metal plate having a convex surface, for reflecting a plurality of incoming electromagnetic waves to a point or a small area; and
a passive sensor placed at said point or area where said reflected electromagnetic waves are reflected to.

2. The omnidirectional electromagnetic sensing device as claimed in claim 1, wherein said passive sensor is an electromagnetic sensor.

3. The omnidirectional electromagnetic sensing device as claimed in claim 1, wherein said convex surface is a cone-shaped surface.

4. The omnidirectional electromagnetic sensing device as claimed in claim 1, wherein said convex surface is a sphere-shaped surface.

5. The omnidirectional electromagnetic sensing device as claimed in claim 1, wherein said convex surface is an ellipse-shaped surface.

6. The omnidirectional electromagnetic sensing device as claimed in claim 1, wherein said convex surface is a hyperboloid-shaped surface.

7. The omnidirectional electromagnetic sensing device as claimed in claim 1, wherein said convex surface is a paraboloid-shaped surface.

8. The omnidirectional electromagnetic sensing device as claimed in claim 1, wherein the material of said metal plate depends on the wavelength of said electromagnetic waves and the shape and size of said convex surface.

9. The omnidirectional electromagnetic sensing device as claimed in claim 1, wherein said point and area depends on the shape of said convex surface.

10. The omnidirectional electromagnetic sensing device as claimed in claim 1, wherein the deviation of said passive sensor from said point or said area is adjustable.

11. The omnidirectional electromagnetic sensing device as claimed in claim 1, further comprising a detection system being triggered by said passive sensor.

12. The omnidirectional electromagnetic sensing device as claimed in claim 1, wherein said electromagnetic sensing device is mounted on a fixed base.

13. The omnidirectional electromagnetic sensing device as claimed in claim 2, wherein said electromagnetic sensing device is used on a mobile appliance.

14. The omnidirectional electromagnetic sensing device as claimed in claim 2, wherein said electromagnetic sensor is a thermal radiation sensor.

15. The omnidirectional electromagnetic sensing device as claimed in claim 8, wherein said material of said metal plate is an aluminum plated-film.

16. The omnidirectional electromagnetic sensing device as claimed in claim 8, wherein said material of said metal plate is a copper plated-film.

17. The omnidirectional electromagnetic sensing device as claimed in claim 8, wherein said material of said metal plate is a gold plated-film.

18. The omnidirectional electromagnetic sensing device as claimed in claim 11, wherein said detection system generates visual signals.

19. The omnidirectional electromagnetic sensor as claimed in claim 11, wherein said detection system generates audio signals.
